(19) United States
(12) Patent Application Publication
(10) Pub. No.: US 2011/0152050 A1
(43) Pub. Date: Jun. 23, 2011

(54) Method and Device for the Production of Packages

(76) Inventors: Thomas Häfker, Langwedel (DE); Hermann Blome, Blender (DE)

(21) Appl. No.: 12/997,997

(22) PCT Filed: Jun. 24, 2009
(86) PCT No.: PCT/EP2009/004547

§ 371 Date: Dec. 14, 2010

(30) Foreign Application Priority Data
Jun. 26, 2008 (DE) 10 2008 029 929.4

(51) Int. Cl. B31B 1/62; B31B 1/04; B31B 1/12; B31B 1/92; B31B 3/00

(52) U.S. Cl. 493/122; 493/84; 493/128; 493/162

(57) ABSTRACT

A method and device for the production of packages for use in the production of cigarette packs (10) of the hinge-lid-box type, in which, usually in a final production step, folding flaps, namely side flaps for forming side walls of the pack, are provided with glue and then outer side flaps are folded. The gluing is done using cold glue, on the one hand, and hot glue, on the other hand. During certain operating phases, only one of the types of glue is transferred, and therefore, with different curing times of the types of glue, it is ensured that the pack is shaped precisely before the glue bonds are solid. It is also ensured that the residence time in a drying turret is sufficient in order to allow at least one of a number of types of glue to set.

The invention relates to a method for producing packs according to the preamble of claim 1. The invention also relates to an apparatus for implementing the method.

In the case of high-performance packaging machines, in particular for producing cigarette packs, the gluing of pack parts, for example of folding flaps which are to be bonded together, poses a particular technical problem. The joint use of two types of glue, namely cold glue, on the one hand, and hot glue (hot melt), on the other hand, for bonding side flaps for forming side walls of a (cigarette) pack of the hinge-lid-box type is known. In the prior art, the different regions or spots of glue are applied to the inside of outer folding flaps or side flaps in a common glue station using glue nozzles assigned to the different types of glue (EP 1 454 829).

The invention deals with the improvement of performance, quality and reliability of the production of packs, in particular (cigarette) packs of the hinge-lid-box type. The object on which the invention is based consists in improving the durability of the packs in the region of glue bonds and of improving the precise dimensional stability and the performance of the packaging machine.

In order to achieve this object, the method according to the invention is characterized in that, in dependence on the operating state of the packaging machine, in particular in dependence on the operating speed and/or cycle speed, alternatively just one type of glue is processed, or both types of glue are processed, for bonding the same folding flaps.

The invention is based on the use of at lest two types of glue with different reaction behaviors, in particular cold glue, on the one hand, and hot glue, on the other hand.

Furthermore, the invention is based on the finding that the glue used or the quickest-curing glue, in the case of a number of types of glue being used for the same glue bond, may result in a solid, stable glue bond only upon completion of an operation which follows the gluing and folding and in which the pack undergoes precise shaping and dimensional stabilization.

It is thus the case according to the invention that, during a phase of relatively low output or cycle speed of the packaging machine, use is made exclusively of glue with a relatively long curing time, in particular cold glue. This prevents the situation where, as a result of premature curing of the glue, the pack is dimensionally stable prior to completion of precise shaping in the region of a shaping subassembly and/or in the region of a shaping turret. It is only when a higher operating speed/cycle speed, which can be derived from the curing behavior of hot glue, is reached that use is made, according to the invention, of both types of glue. The time window which is critical for the types of glue used can be determined from the point in time at which the glue is applied to the pack or blank, on the one hand, and that at which the pack is shaped in the region of the shaping subassembly or shaping turret, on the other hand.

A separate theme addressed by the invention is that of the residence time of the packs in the shaping subassembly, preferably in shaping pockets of a revolving shaping or drying turret. This residence time can be established according to the invention such that, following and/or during shaping, the packs remain in the shaping subassembly at least until at least one of the types of glue processed has cured on a permanent basis.

Another special feature consists in the fact that the packs, which are transported preferably along a rectilinear pack path and are folded at least partially during transportation, are transferred to a shaping and aligning station following the pack path. This station has mechanisms which grip the pack, preferably on all sides, and give it its precise (cuboidal) configuration. The shaping of the packs preferably takes place in the region of a transfer turret which transfers the packs to a drying turret following partial rotation. This drying turret transports the packs along part of its circumference, the precise pack shape being maintained in the process, until the packs are transferred to a removal conveyor. When the packs leave the drying turret, at least one type of glue on the glued-together folding flaps or other pack parts has (fully) set or cured, and therefore the packs are dimensionally stable. In respect of the number of cooperating pockets, the shaping turret may be dimensioned such that, when the packs are pushed out, merely one glue bond or type of glue is fixed, and one or more further glue bonds have not yet fully cured.

It is an innovation of the apparatus that the (cigarette) packs of the hinge-lid-box type can be transported along an in particular rectilinear pack path with a plurality of, in particular two, successive glue stations with glue subassemblies arranged in the region thereof. The first glue subassembly serves for applying cold glue. The following glue subassembly, as seen in the conveying direction, serves for feeding hot glue. Glue nozzles are directed horizontally such that portions of glue, in particular spots of glue, are transferred in an upright plane, in accordance with a particular pattern, onto folding flaps, preferably onto inner side flaps of the side walls of a pack, these side walls comprising inner and outer side flaps.

Further (special) features of the invention will be explained in more detail hereinbelow with reference to the drawings, in which:

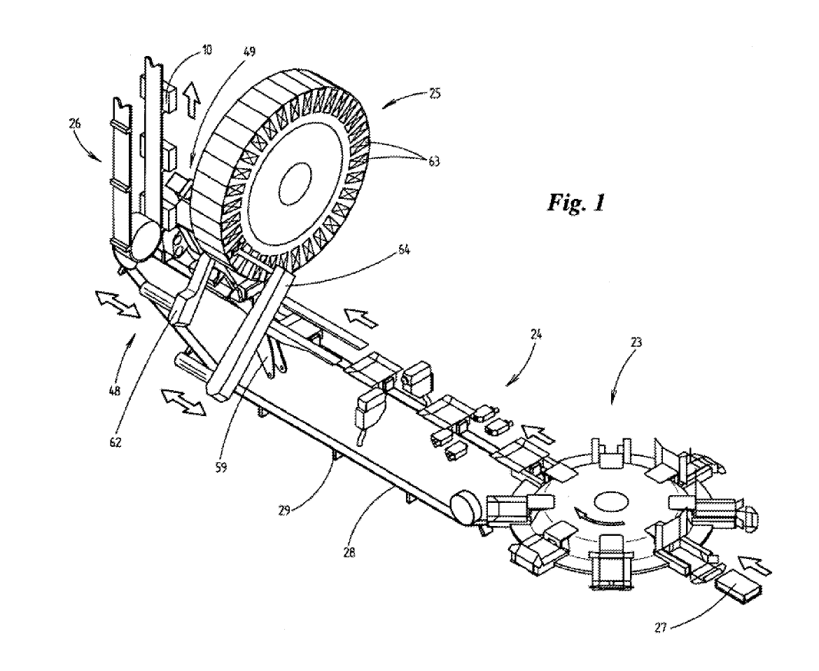

FIG. 1 shows a perspective illustration of part of packaging machine,

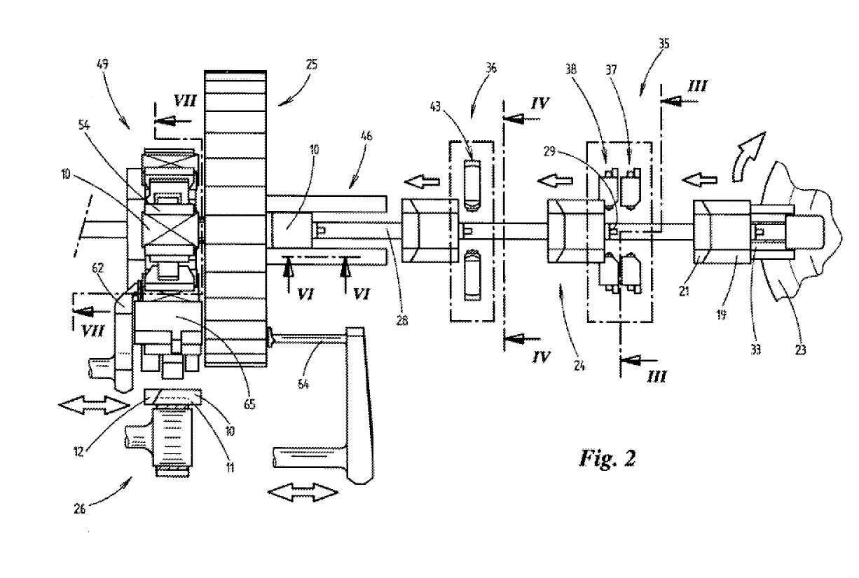

FIG. 2 shows a plan view of the part of the packaging machine according to FIG. 1,

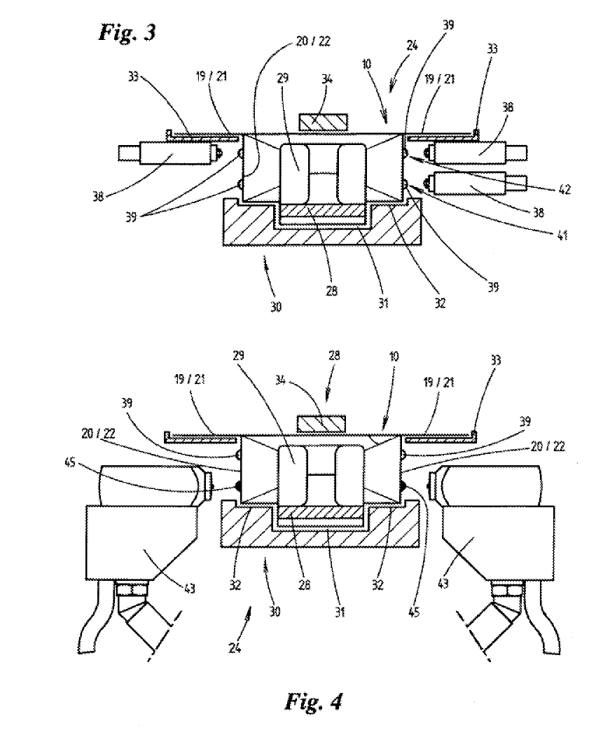

FIG. 3 shows, on an enlarged scale, a detail of the apparatus according to FIG. 2, namely of a glue station in cross section along section plane III-III in FIG. 2,

FIG. 4 shows an illustration analogous to FIG. 3, this time along section plane IV-IV from FIG. 2,

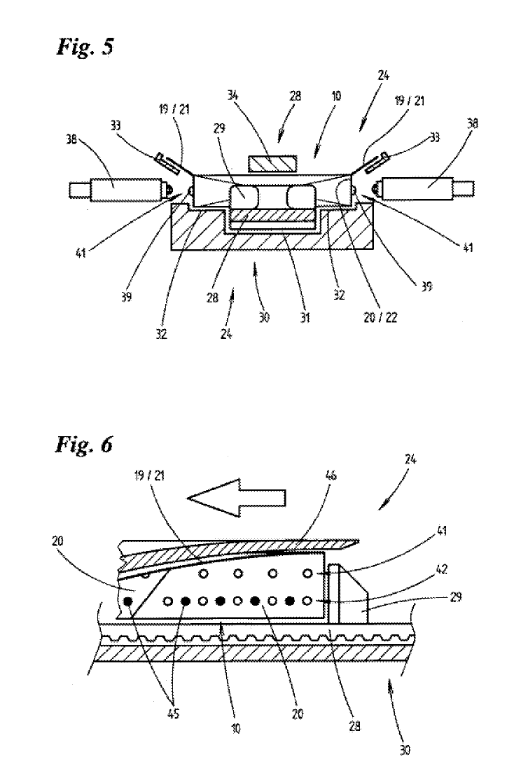

FIG. 5 shows a cross section of another exemplary embodiment of the apparatus, analogous to the illustrations according to FIGS. 3 and 4,

FIG. 6 shows, on a further-enlarged scale, a detail in side view, partially in section along section plane VI-VI in FIG. 2,

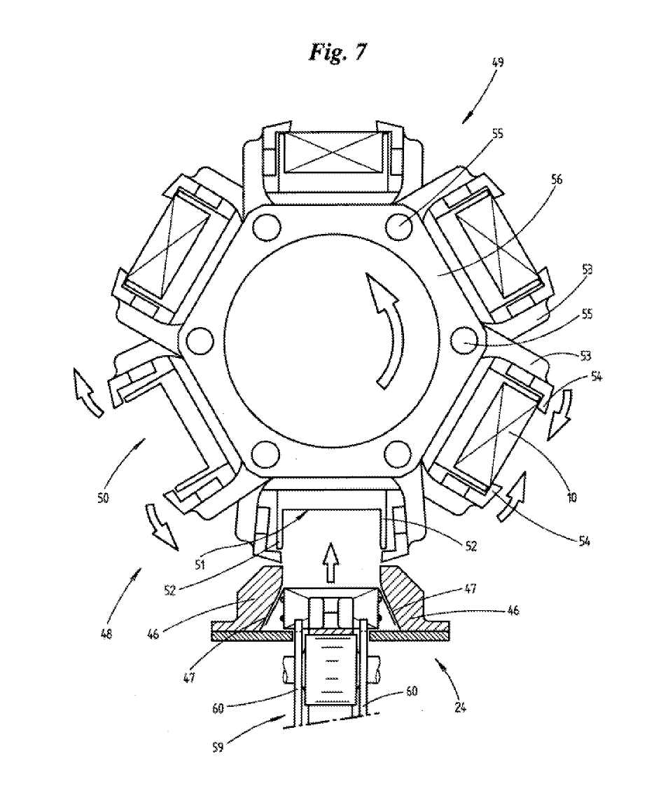

FIG. 7 shows part of a shaping station with adjusting mechanism in an axial view corresponding to section plane and viewing plane VII-VII in FIG. 2,

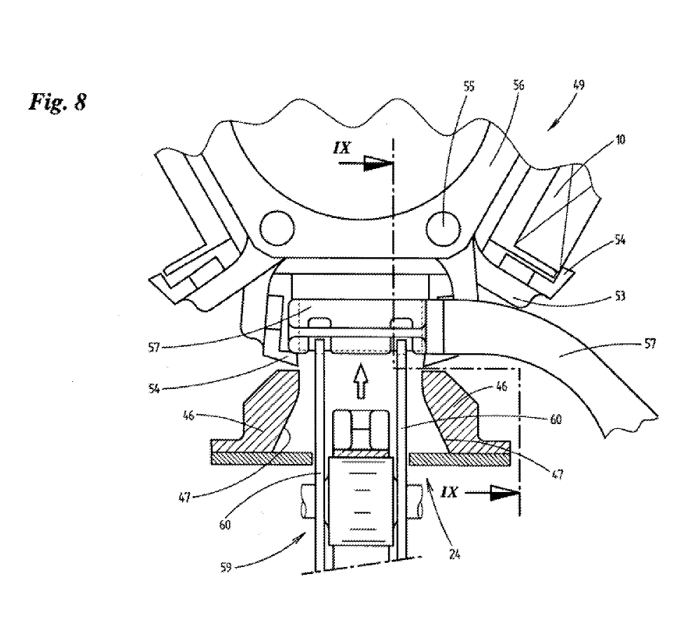

FIG. 8 shows, on an enlarged scale, the illustration of a detail of the station according to FIG. 7,

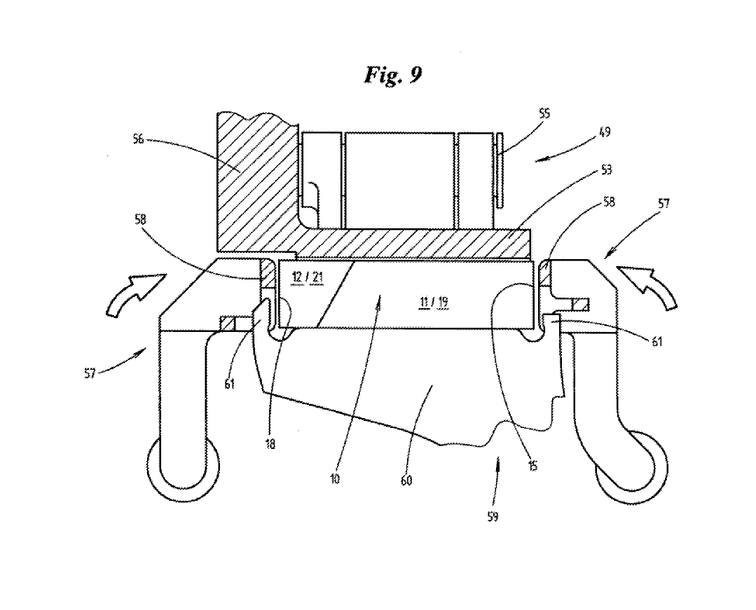

FIG. 9 shows, on an enlarged scale, a further detail of the shaping station in a cross section or axial section along section plane IX-IX in FIG. 8,

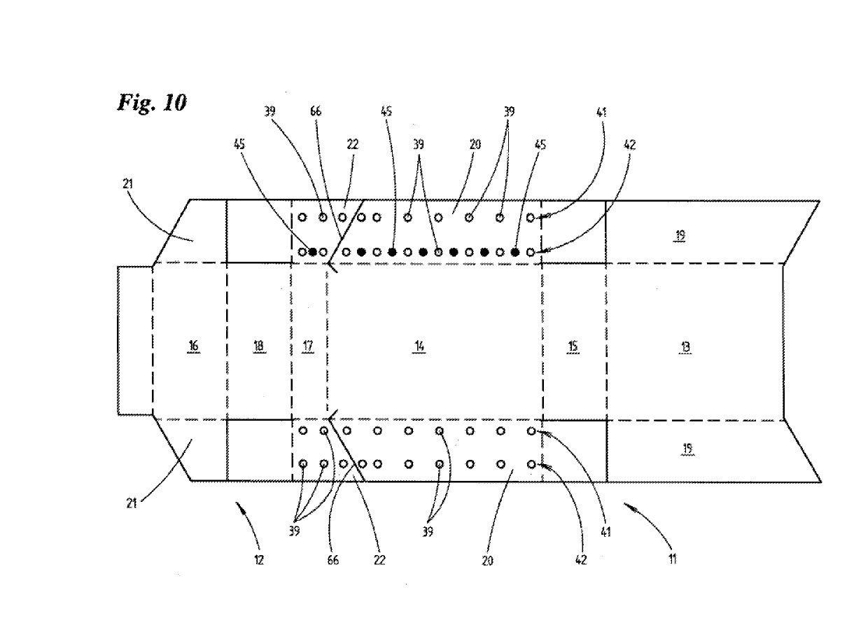

FIG. 10 shows a blank for a hinge-lid (cigarette) box with a pattern of glue, and

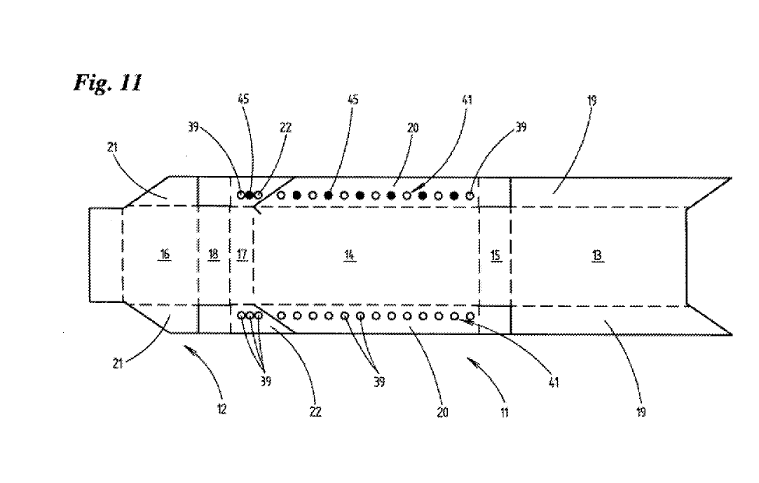

FIG. 11 shows a blank corresponding to the blank according to FIG. 10 for a narrow hinge-lid box.

The drawings show a preferred application area, namely the production of packs 10 of the hinge-lid-box type for cigarettes. This type of pack comprises a box part 11 and lid 12. A typical blank for this form of pack is shown in FIG. 10. The box part 11 has a box front wall 13 and a box rear wall 14, which are connected to one another via a base wall 15. The lid 12 contains a lid front wall 16, a lid rear wall 17 and, therebetween, an end wall 18. Side walls of the pack, namely of the box part 11 on the one hand and of the lid 12 on the other hand, each comprise two wholly or partially overlapping folding flaps. Laterally outer box side flaps 19 are provided on the box front wall 13, and laterally inner box side flaps 20 are provided on the box rear wall 14. Correspondingly, in the region of lid 12, outer lid side flaps 21 are provided on the front wall 16 of the lid 12, and inner lid side flaps 22 are provided on the rear wall of the lid 12. The blank is folded such that the associated side flaps 19 and 20, on the one hand, and 21 and 22 on the other hand, overlap one another and are bonded together by glue in order to form the side walls.

The apparatus illustrated schematically in FIG. 1, as part of a packaging machine for producing cigarette packs of the hinge-lid-box type, comprises a folding turret 23, an adjoining (rectilinear) pack path 24, a shaping subassembly in conjunction with a downstream drying turret 25 and a removal conveyor 26 for the finished packs 10.

The pack 10 contains a cigarette block 27—a cigarette group wrapped in an inner blank—which is wrapped in the blank according to FIG. 9 in the region of the folding turret 23 to form the hinge-lid box. The largely completed pack 10 is pushed radially out of pockets of the folding turret 25 and transferred onto the pack path 24.

When the packs 10 enter into the pack path 24, the folding process for the blank has been largely completed, that is to say apart from the outer side flaps 19, 21. These extend in a wing-like manner in an upper, horizontal plane, with the box front wall 13 and lid front wall 16 oriented upward. The inner side flaps 20 and 22 have already been folded into an upright plane, with abutment against the pack contents, that is to say against the cigarette block 27.

In the region of the pack path 24, the packs 10 are transported by an endless conveyor at a distance apart from one another. This endless conveyor is designed as a belt conveyor 28, to be precise as a toothed belt. Drivers 29 are arranged on the free side, and these drivers grip, and transport, a respective pack 10 in the region of the base wall 15 at the rear. The packs 10 rest on the belt conveyor 28 and/or on a carrying profile 30 which runs in the longitudinal direction of the pack path 24, with their longitudinal extent oriented in the conveying direction. This carrying profile 30 here comprises a rail-like shaping component with a central depression 31 into which a conveying strand of the belt conveyor 28 enters. Supporting surfaces 32 are formed laterally alongside the same as a lateral support for corresponding peripheral regions of the pack 10.

It is also the case that guiding and supporting mechanisms are provided on the upper side of the pack 10, in the region of the pack path 24. The sideways directed folding flaps, namely box side flaps 19 and lid side flaps 21, are located on carrying mechanisms, namely lateral guide profiles 33 with peripheral edging. Also arranged on the upper side of the packs 10 is a rail-like holding-down means 34 which runs in the conveying direction and retains the packs 10 in the precise position on or in the pack path 24.

The packs 10 are transported preferably continuously along the pack path 24. In the process, folding flaps, in the present case the upright inner box side flaps 20 and lid side flaps 22, are provided with glue. These flaps are then folded, to be precise into the end position, with abutment against the associated side flaps 20, 22. The (outer) folding flaps 19, 21 are preferably moved, in the region of the pack path 24, into an intermediate folding position, namely into an oblique position at an acute angle to the side flaps 20, 22.

Glue stations are set up in the region of the pack path 24. The apparatus is set up to transfer two different types of glue, namely, in particular, cold glue, on the one hand, and hot glue (hot melt), on the other hand, onto the pack 10. A first glue station 35 serves for transferring preferably cold glue. A second glue station 36, which follows downstream in the conveying direction, is set up, in particular, for transferring hot glue.

Each glue station 35, 36 has at least one glue subassembly, the first glue station 35, in the case of the present exemplary embodiment, having two glue subassemblies 37, 38, one on either side of the pack path 24. The glue subassemblies 37, 38 have glue nozzles for transferring spots 39 of glue onto the pack 10. It is a special feature that the portions of glue are discharged in the horizontal direction and are transferred onto an upright folding flap 20, 22. Furthermore, the glue subassemblies 37, 38 of the first glue station 35 are designed, or arranged, so as to produce two rows 41, 42 of spots of the glue located one above the other. The first, lower row 42 of spots is applied by a first glue subassembly 37 and the second, upper row 41 of spots is applied by a second glue subassembly 38, which follows downstream in the conveying direction. The glue subassemblies 37, 38 are offset vertically in relation to one another at least in respect of the arrangement of the nozzles.

The downstream glue station 36, in the present case, comprises just one glue subassembly 33 (on either side of the pack path 24) for transferring an individual row 44 of spots 45 of a different type of glue, in particular of hot melt. This row 44 of spots is applied in a lower plane—in relation to the pack path 24. In particular, the spots 45 of hot melt are applied approximately centrally between the spots 39 of the row 42 of spots, that is to say adjacent to a free periphery of the outer side flaps 19, 21, which are intended for bonding to the side flaps 20, 22. The spots 39, 45 of glue can be transferred by appropriately designed glue subassemblies while the packs 10 are at a standstill. In the present case, the spots 39, 45 of glue are transferred onto the side flaps 20, 22 by individual nozzles as the packs 10 are moving.

Following the glue station 36, the packs 10 pass into the region of a folding station with folding mechanisms which are designed here as folding diverters 46 on either side of the pack path 24. The shaped, rail-like folding diverters 46 cause the side flaps 19, 21 to be folded over downward during transportation, in the present case into an intermediate folding position (FIG. 7). For this purpose, the folding diverters 46 are designed in a particular manner, namely with obliquely directed folding surfaces 47 (FIG. 7). The folding flaps 19, 21 are located in an oblique position of approximately 15° to 30°, and there is therefore no contact with the applications or spots 39, 45 of glue.

The packs 10 are transported on the pack path 24 into the region of a shaping station 48. In this region, the packs 10 are folded to completion—in respect of the folding flaps 19, 21—and made into a geometrically precise shape by mechanisms which butt against a number of opposite sides or surfaces and transmit aligning forces thereto. Thereafter, the pack 10, which has been completed to this extent, but has not yet cured fully in respect of the glue bonds, is transferred to the drying turret 25. When the packs 10 leave the latter, the glue bonds have set to the extent that the packs 10 are dimensionally stable.

The mechanisms for shaping and aligning the packs 10 are, at the same time, mechanisms belonging to a conveyor for the packs 10 for transferring the same from the pack path 24 to the drying turret 25. This conveyor, in the present case, is a transfer turret 49. The latter is mounted in a rotatable manner in an (upright) plane such that it is offset in relation to the plane of the drying turret 25. The transfer turret 49 is located above the pack path 24, and it is therefore possible for a respective pack 10, by virtue of being raised up from the pack path 24, to be introduced into a downwardly oriented holder or shaping pocket 50 of the transfer turret 49. The transfer turret 49 is located, as seen in the transporting direction of the packs 10, on that side of the drying turret 25 which is opposite to the glue stations 35, 36.

The transfer turret 49 is designed in a particular manner in respect of multifunctioning. The shaping pocket 50 contains a shaping component 51 which has a U-shaped cross section, to be precise which has the precise dimensions of a pack 10. The latter is moved upward out of the region of the folding diverter 46. The cross-sectional contour of the folding diverter 46 means that the latter acts like a mouthpiece and, when the pack is moved upward, folds the side flaps 19, 21 into abutment against the inner side flaps 20, 22. This completes the pack 10, and the latter thus passes into the shaping pocket 50 or the shaping component 51. The latter has lateral limbs 52 butting against the side surfaces of the pack 10, namely against the previously folded side flaps 19, 21.

The packs 10 are fixed in the shaping pocket 50, of the transfer turret 49, to be precise in the shaping component 51, by movable retaining mechanisms. For this purpose, each shaping pocket 50 is assigned retaining fingers 53 which are located opposite one another. These retaining fingers are of angled design with a transversely directed retaining limb 54 which, in a closed position of the shaping pocket 50, butts peripherally against the free outer side of the pack 10. In the open position of the shaping pocket 50, the pivotable retaining fingers 53 have been moved into a position in which free ends of the retaining limbs 54 are located in extension of the plane bounded by the folding diverters 46 or the folding surfaces 47, and they thus form a functional part of a guide well for the pack 10 en route into the shaping pocket 50. The retaining fingers 53 are mounted by means of pivot bearings 55 on an annular pocket carrier 56 of the transfer turret 49.

The limbs 52 of the shaping components 51 are active to provide precise shaping in the region of elongate side surfaces or side walls of the packs 10, namely in the region of the side flaps 19 . . . 22. To provide for shaping and dimensional stability, further mechanisms are active in the region of the shaping station 48. Directly in the region where the packs 10 are transferred to the transfer turret 49, namely once a pack 10 has entered into a shaping pocket 50, aligning means 57 are active on mutually opposite sides of the pack 10, namely at the base wall 15 and end wall 18. The aligning means 57 preferably come into abutment against the pack before the retaining fingers 53 have moved into the closed position. The aligning means 57 are mounted in a fixed position such that they can be pivoted (FIGS. 8 and 9). Each aligning means 57, which is designed as a pivoting arm, butts against the pack 10 by way of an aligning crosspiece 58. The aligning means 57 make a contribution to shaping the pack 10, but in particular to the correct alignment of the same. The aligning means 57 are moved back into a starting position before the transfer turret 49 executes the next rotary cycle.

A transfer mechanism, namely a lifting means 59, serves for transferring the packs 10 from the pack path 24 to the transfer turret 49. This lifting means is mounted in a fixed position in the region of the pack path 24. Two spaced-apart lifting walls 60 are used for the purpose of raising a pack 10. These lifting walls grip a pack 10, in the region of the shaping station 48, on the underside, to be precise around the periphery (FIG. 8). By virtue of the lifting means 59 or of the lifting walls 60 being moved upward, the pack 10 is introduced into the shaping pocket 50 or into the shaping component 51. The lifting walls 60 are provided around the periphery with protrusions 61, between which the pack 10 is accommodated (FIG. 9).

The packs 10 are each introduced into a downwardly oriented shaping pocket 50 of the transfer turret 49. Thereafter, the transfer turret 49 is rotated (in the counterclockwise direction) into a transfer position, immediately upstream of the charging station. Accordingly, the packs 10 are retained in the transfer turret 49 over a maximum transporting distance and are thus stabilized in respect of precise shaping.

The packs 10 are transferred to the drying turret 25 by a pusher 62 which can be moved in an axis-parallel manner and pushes the pack 10—with the retaining fingers 53 open—axially out of the shaping pocket 50 and directly into a precisely positioned drying pocket 63 of the drying turret 25. These drying pockets 63, which are arranged in large numbers along the circumference of the drying turret 25, form a cross-sectionally rectangular channel which is open on either side in the axial direction and in which a respective pack 10 fits in a play-free manner. The glue bonds are thus set as the precise pack shape is being maintained. Moreover, the drying turret 25 is positioned in a conventional manner.

The packs 10 are moved along a maximum circular transporting distance by the drying turret 25 and, in the region of a pushing-out station, are pushed out of the respective drying pockets 63 by a pushing-out means 64 and transferred onto the removal conveyor 26. The pack 10 exiting from the drying turret 25 is transferred to an intermediate mechanism, namely to a pivotable platform 65, which pivots the pack 10 into the relative position which is necessary for removal, and in which a longitudinal side of the pack 10 is directed downward.

The arrangement is suitable for packs 10 of different dimensions. FIG. 11 shows a blank of a cigarette pack of the hinge-lid-box type for a smaller number of cigarettes or for cigarettes of a smaller diameter. In the case of this type of pack, the side flaps 19, 20, 21, 22 are of correspondingly smaller width—in comparison with the standard pack according to FIG. 10. It is thus provided that the side flaps 19 and 20, on the one hand, and the side flaps 21 and 22, on the other hand, are bonded to one another only by spots 39, 45 of glue in a single row 41 of spots. These spots of glue may consist entirely of spots 39 of cold glue or of spots 39 of cold glue and spots 45 of hot melt in the same row 41 of spots.

The positioning of regions of glue with different curing behaviors constitutes a special feature. In the case of a standard pack (FIG. 10), two parallel regions of glue, namely rows 41, 42 of spots, are formed on the (inner) side flaps 20, 22. The number of spots 39 of glue in each row 41, 42 of spots is selected with regard to sustained durability. The spots 39 of glue within the rows 41, 42 of spots are oriented in the longitudinal and transverse directions. A relatively large number of spots 39 of glue are provided, at correspondingly relatively small distances apart, in the region of the trapezoidal lid side flaps 22. In the present case, three and two spots 39 of glue are respectively provided in each row 41, 42 of spots. Adjacent to an oblique edge 66 for delimiting the folding flaps 20 and 22, an additional spot 39 of glue is positioned in the region of the box side flap 20 in order to ensure enhanced bonding strength for folding flaps in the region of peripheries.

For the application of glue bonds made of two (or possibly more) types of glue, in the case of the present example (FIG. 10) additional spots 45 of glue are assigned to the row 41 of spots, that is to say are positioned between adjacent spots 39 of glue in this row 41 of spots. The spots 45 of glue are arranged approximately centrally between adjacent spots 39 of glue and are aligned therewith. This provides enhanced bonding strength for the finished pack 10 in the region of a peripheral strip of the outer box side flap 19 and of the lid side flap 21.

In the case of the blank according to FIG. 10, the procedure is such that, if use is made of two types of glue, individual spots 39 of a first type of glue, in particular cold glue, are replaced by spots 45 of a second type of glue, in particular hot glue.

The glue subassemblies 37, 38 and the glue subassembly 43 can be controlled correspondingly, and therefore the abovedescribed pattern of glue is transferred during the transporting movement. It is provided that in a first instance spots of cold glue and then, in a precisely positioned manner, spots of hot glue are transferred. If, according to FIG. 11, the type of glue is changed over for certain spots of glue, the glue subassembly 37 or 38 is controlled such that the spots 39 of glue are applied with larger distances between them, in order to create free interspaces for the subsequent application of the spots 45 of glue.

During the production of the packs, in particular during the gluing of folding flaps or other parts of the pack, the selection of the currently usable types of glue is controlled in dependence on the operating state of the packaging machine. The selection of the type of glue and the additional processing of a second type of glue are selected in accordance with the known material data for the glue and the known performance of the machine. Selection is based on the following considerations: for a certain period of time extending, for example, from the point in time at which the glue is applied, via the folding of the glued folding flaps, that is to say in particular the operation of folding over the side flaps 19, 21, until the pack, which has been folded to completion, is accommodated in a shaping subassembly, with a shaping and shape-maintaining action, the glue must not cure, in order that it is possible, in the shaping subassembly, to align the glued folding flaps in order to form a precise pack shape. In the case of a concrete exemplary embodiment with an assumed machine output of 600 cycles/min, exclusively cold glue is processed while the machine is operating at a reduced cycle speed, for example up to 120 cycles/min. When the machine reaches an output above, for example, 120 cycles/min, hot glue is processed in addition.

A separate theme addressed is that of the dimensioning of the shaping subassembly, in particular of the drying turret 25, in respect of the number of drying pockets 63. It is an aim to keep the drying turret 25 as small as possible, with the proviso that the packs 10 remain in the drying turret 25 during a rotation, in particular (only) during a partial rotation, of the same. It has to be ensured that at least one of the types of glue in the glue bonds has fully set/cured when the pack 10 leaves the drying turret 25 in the region of the pushing-out station. While the machine is operating at maximum output, the residence time is geared to the curing time of hot glue. In the case of the exemplary embodiment shown, the drying turret 25 is provided with at least 20, and not more than 30, active drying pockets 63.

The drying turret 25 can be dimensioned and/or the cycle speed for switching over the gluing system can be determined as follows:

### Constants:

| | |
|---|---|
| Operating cycle in which the folding flaps | Z_{I} = 1 |
| 19 . . . 22 which are to be adhesively bond- | |
| ed are pressed against one another and the | |
| pack 10 is formed: | |
| Curing time of cold glue | t_{K} = 15 sec |
| Maximum machine output | nₘₐₓ = 600 cycles/min |

### Variables:

| | |
|---|---|
| Curing time of hot glue | t_{H} |
| Optimum number of pockets in the folding turret | z_{I} |
| Duration of operating cycle of packaging machine | t_{T} |
| Number of pockets in the folding turret for cold glue | z_{K} |
| Number of pockets in the folding turret for hot glue | z_{H} |
| Cycle speed/rotational speed at which hot glue is | n_{Z} |
| activated | |

These given values make it possible to determine, for a preferred embodiment, the number of operating cycles until the dimensionally stable packs 10 are released, as follows:

Specified value: hot-glue-curing time, which can be selected within limits, is, for example, t_{H}=0.5 sec.

The cycle duration t_{T} can be established from

$${t}_{T} = \frac{{t}_{H}}{{z}_{I}} {t}_{T} = \frac{0.5}{1} = 0.5 \frac{sec}{cycles}$$

This makes it possible to calculate the rotational speed n_{Z} at which hot glue is activated, that is to say the cycle speed of the machine for the additional processing of hot glue:

$${n}_{Z} = \frac{1}{{t}_{T}} * 60 [ \frac{cycles}{sec} * \frac{sec}{min} ] {n}_{Z} = \frac{1}{0.5} * 60 = 120 \frac{cycles}{min}$$

The predetermined parameters can be used to determine the number z_{K} of drying pockets 63 necessary until cold glue has cured:

$${z}_{K} = \frac{{n}_{Z}}{60} * {t}_{K} [ \frac{cycles}{min} * 60 \frac{min}{sec} * sec ] {z}_{K} = \frac{120}{60} * 15 = 30$$

On the basis of the given values and with (a maximum of) 120 operating cycles/min for exclusive processing of cold glue, accordingly, the drying turret 25 should be provided with thirty drying pockets 63.

The number z_{H} of drying pockets 63 which is necessary for the curing of hot glue on the basis of the given values can be determined as follows:

$${z}_{H} = \frac{{n}_{max}}{60} * {t}_{H} [ \frac{cycles}{min} * 60 \frac{min}{sec} * sec ] {z}_{H} = \frac{600}{60} * 0.5 = 5$$

It is therefore the case that (merely) five pockets or operating cycles are required for curing the areas of hot glue. In the case of this particular embodiment, it is possible, using the same basic design of the packaging machine, to provide a higher machine output without changing the drying turret 25.

In the case of the present method with “hybrid gluing”, the curing time t_{H} of the hot glue, to be precise the shortest possible curing time t_{H} of a hot glue, constitutes the critical feature. Series of tests using commercially available hot glues which can be used for cigarette packs have determined the shortest curing time as t_{H}=0.5 s. This means that the operations of joining together and shaping the pack 10 have to be completed after t_{H}=0.5 s. This means that:

| | |
|---|---|
| Number of drying pockets 63 in the drying turret 25: | Z_{K} = 30 |
| Rotational speeds at which hot glue is activated: | n_{Z} = 120 cycles/min |

The highest curing time which is admissible for hot glue, for a drying wheel with 30 drying pockets, is:

$${t}_{H} = \frac{{z}_{K} * 60}{{n}_{max}} = 3 sec$$

### LIST OF DESIGNATIONS

10 Pack
11 Box part
12 Lid
13 Box front wall
14 Box rear wall
15 Base wall
16 Lid front wall
17 Lid rear wall
18 End wall
19 Box side flap (outer)
20 Box side flap (inner)
21 Lid side flap (outer)
22 Lid side flap (inner)
23 Folding turret
24 Pack path
25 Drying turret
26 Removal conveyor
27 Cigarette block
28 Belt conveyor
29 Driver
30 Carrying profile
31 Depression
32 Supporting surface
33 Guide profile
34 Holding-down means
35 Glue station
36 Glue station
37 Glue subassembly
38 Glue subassembly
39 Spot of glue
41 Row of spots
42 Row of spots
43 Glue subassembly
44 Row of spots
45 Spots of (hot-melt) glue
46 Folding diverter
47 Folding surface
48 Shaping station
49 Transfer turret
50 Shaping pocket
51 Shaping component
52 Limb
53 Retaining finger
54 Retaining limb
55 Pivot bearing
56 Pocket carrier
57 Aligning means
58 Aligning crosspiece
59 Lifting means
60 Lifting wall
61 Protrusion
62 Pusher
63 Drying pocket
64 Pushing-out means
65 Platform
66 Oblique edge

1. A method for producing packs with adhesively bonded folding flaps (19, 20; 21, 22) or other pack parts, in particular for producing cigarette packs of the hinge-lid-box/hinge-lid type, wherein use is made of at least two types of glue with different curing behaviors, in particular with different curing durations, preferably cold glue, on the one hand, and hot glue, on the other hand, comprising:
in dependence on the operating state of the packaging machine, in particular in dependence on the operating speed and/or cycle speed, alternatively just one type of glue is processed, or both types of glue are processed, for bonding the same folding flaps (19, 20; 21, 22) such that,
prior to the glue curing, the pack (10) has, or at least the glued-together folding flaps and/or pack parts have, achieved the final form.

2. The method as claimed in claim 1, further comprising, once the glue has been applied to the regions, in particular folding flaps (19, 20; 21, 22), which are to be bonded together, and once the folding flaps (19, 20; 21, 22) have been brought together, the packs (10) are fed to at least one shaping arrangement in which the packs (10) are accommodated until at least one of the types of glues processed has fully cured/set, with the outer shape of the pack (10) being stabilized and adjusted in the process, in particular in a shaping or drying turret (25) with a plurality of holders or drying pockets (63) for a respective pack (10), wherein, in dependence on the operation of the packaging machine, in particular on the operating speed, use is made of only those types of glue which, until the packs (10) enter into the shaping subassembly and/or into the shaping turret (25), have not yet cured, such that it is possible to carry out adjustments in the region of the bonded-together folding flaps (19, 20; 21, 22) for precise shaping purposes.

3. The method as claimed in claim 1, wherein, up to a predetermined adjustable operating speed of the packaging machine, exclusively glue with a relatively long curing time is processed, in particular cold glue, and in that, when this operating speed is exceeded, further types of glue, in particular hot melt, are processed in addition in order to bond the same folding flaps (19, 20; 21, 22).

4. The method as claimed in claim 1, wherein the shaping subassembly or a plurality of shaping subassemblies, in particular the drying turret (25) and possibly a transfer turret (49) with shaping pockets (50) for accommodating a respective pack (10), is or are designed in respect of the residence time of the packs (10) such that the glue which is processed exclusivelyat relatively low operating speed of the packaging machine, cold glue, cures fully as the packs (10) are residing in the shaping subassembly and/or in the shaping subassemblies.

5. The method as claimed in claim 1, wherein the additional use of glue with a short curing time is determined in dependence on the residence time of a pack (10) from the point in time at which the glue is applied to the pack (10) and/or the folding flap (19, 20; 21, 22) until the pack (10), once folded to completion, enters into the shaping subassembly, namely such that the curing time of the glue used is longer than the residence time of the glued pack (10) until entry into the shaping subassembly.

6. The method as claimed in claim 1, wherein, following a final folding step, the glued, folded packs (10) are introduced into a shaping subassembly, in particular into the transfer turret (49), with shaping pockets (50) which have mechanisms for precisely aligning the pockets and/or the glued-together folding flaps such that the pack (10) obtains the precise shape and dimensions as it is residing in the shaping subassembly or transfer turret (49).

7. The method as claimed in claim 1, further comprising:
a) the glue is applied, in the region of a horizontal conveying section of the packs (10), in particular in the region of a pack path (24), to the folding flaps (19, 20; 21, 22) which are to be bonded together, to the outside of an inner flap folded into an upright position, the inner box side flap (20) or inner lid side flap (22) of a cigarette pack of the hinge-lid-box type,
b) the glue is transferred essentially horizontally onto the folding flaps (20, 22) by glue subassemblies (37, 38; 43) with horizontally directed glue nozzles to form patches or spots (39, 45) of glue,
c) associated folding flaps, in particular outer box side flaps (19) and outer lid side flaps (22), are then folded from a starting position and/or into abutment against the folding flaps (20, 22) provided with glue, and
d) the packs which have been folded to completion are introduced into a shaping pocket (50) of an intermediate conveyor, in particular of the transfer turret (49).

8. The method as claimed in claim 7, wherein, once the glue has been applied to the inner folding flaps (20, 22), in the region of the pack path (24), the outer folding flaps (19, 21) are folded into an intermediate position, in particular at an acute angle to the glued folding flaps (20, 22), without making contact with the patches or spots (39, 45) of glue, and in that, immediately prior to introduction into a shaping pocket (50), the folding flaps (19, 21) are folded into the appropriate end position, during an upwardly directed transfer movement of the pack from the pack path (24) into the shaping pocket (50).

9. The method as claimed in claim 7, wherein the glue is, in particular spots (39, 45) of glue are, transferred in successive glue stations (35, 36) onto the folding flaps (19, 20; 21, 22) which are to be glued, in particular cold glue in a first glue station (35) in the conveying direction, and hot-melt glue in a second glue station (36), with horizontally directed glue nozzles in each case.

10. The method as claimed in claim 1, wherein the packs (10) in the shaping pockets (50) of the transfer turret (49), as they are rotated part of the way around the transfer turret (49), are given a precise shape and dimensioning and thereafter, by axis-parallel displacement, are introduced into a drying pocket (63) of the drying turret (26), wherein the pack (10) resides in the associated drying pocket (63) until at least one type of glue has cured fully when the pack (10) is pushed out of the drying pocket (63).

11. The method as claimed in claim 1, wherein, during the production of cigarette packs of the hinge-lid-box type, the folding flaps (20, 22) are provided with a plurality of, in particular two, rows (41, 42) of spots (39) of glue, in particular such that at least one of the rows (41, 42) of spots, in the processing of a number of types of glue, have additional spots of a second type of glue, in particular spots (45) of hot-melt, which are positioned between the spots (39) of cold glue.

12. The method as claimed in claim 1, wherein, in particular in the case of cigarette packs of the hinge-lid-box type with relatively small transverse dimensioning, the folding flaps (20, 22) are provided with a centrally arranged row (44) of spots (39) of cold glue and, upon activation of hot glue, are provided with spots (45) of hot glue within the same row (44) of spots, such that the number of spots (39) of cold glue is reduced when hot glue is applied in addition.

13. An apparatus for producing packs (10), in particular cigarette packs of the hinge-lid-box/hinge-lid type, having a folding subassembly, in particular folding turret (23), for folding blanks made of thin cardboard or similar packaging material, wherein the largely finished pack (10) can be pushed out of the folding turret (23) into a pack conveyor, in particular into a radially adjoining, rectilinear pack path (24) for completing the pack (10) by virtue of inner folding flaps (20, 22) being glued and of associated outer folding flaps (19, 21) being folded, comprising:
a) two successive glue stations (35, 36) for transferring cold glue, on the one hand, and hot glue, on the other hand, onto the folding flaps (20, 22) are arranged in the region of the pack conveyor, in particular of the pack path (24),
b) each glue station (35, 36) has at least one glue subassembly (37, 38; 43) assigned to one type of glue or the other,
c) the glue stations (35, 36) are followed by a folding station with folding mechanisms, in particular folding diverters (46), for folding over the folding flaps (19, 21),
d) following the pack conveyor or the pack path (24), the packs (10) can each be pushed into a drying pocket of a drying turret, and
e) following transportation of the packs (10) by the drying turret (25), along part of the circumference thereof, the packs (10) can each be pushed out of the drying pocket (48) and transferred to a removal conveyor (26).

14. The apparatus as claimed in claim 13, wherein the packs (10), which are transported continuously in the region of the pack path (24) by an endless conveyor, in particular a belt conveyor (28), rest on an underlying surface, in particular on a carrying profile (30), which extends right into the region of a shaping station (48), wherein mechanisms are active in the shaping station (48) in order to fold the pack (10) to completion and/or to shape the finished packs (10) precisely and/or to transport them away.

15. The apparatus as claimed in claim 13, wherein, in the region of the shaping station (48), the packs (10) can be fed to an intermediate conveyor, in particular to a transfer turret (49), which transfers the packs (10) to a drying turret (25) with drying pockets (63) for a respective pack (10), wherein, following rotation of the drying turret (25) along part of the circumference thereof, once at least one type of glue has cured, the packs (10) can be pushed out of the drying turret (25) and can be fed to a removal conveyor (26), which is designed as a an upright belt conveyor.

16. The apparatus as claimed in claim 15, wherein the transfer turret (49) is a shaping subassembly with shaping pockets (50) for precisely shaping the pack, with areas of glue not yet cured, during transportation of the packs by the transfer turret (49).

17. The apparatus as claimed in claim 13 wherein the packs (10) can be folded in the region of the pack path (24) by folding mechanisms, in particular folding diverters (46), such that outer folding flaps, namely box side flaps (19) and lid side flaps (21), can be folded into an obliquely directed intermediate folding position without the areas of glue making contact with the folding flaps (20, 22) provided with glue, and in that the outer folding flaps (19, 21), during transfer to the transfer turret (49), can be folded into the end position, in particular by virtue of the pack path (24) being raised by a lifting mechanism (29) in conjunction with the folding diverters (46), which are designed in the form of a mouthpiece.

18. The apparatus as claimed in claim 15 wherein the shaping pockets (50) of the transfer turret (49) have mechanisms for shaping and aligning the packs (10), in particular a cross-sectionally U-shaped shaping component (51) corresponding to the dimensions of the pack (10) and/or aligning means (57) which act in the region of free pack surfaces, in particular base wall (15) and end wall (18), and are brought into abutment against the free pack surfaces following introduction of the pack (10) into the shaping pocket (50).

19. The apparatus as claimed in claim 15 wherein, following partial rotation of the transfer turret (49), the packs (10) can be pushed axially out of the shaping pocket (50) and into an adjacent drying pocket (63) of the drying turret (25), wherein the aligning means (57) are arranged at a fixed location in the region where the packs (10) are pushed into the shaping pocket (50) of the transfer turret (49).

20. The apparatus as claimed in claim 13 wherein the drying turret (25) and transfer turret (49) are arranged in offset, upright planes, in respect of relative positioning in particular such that the packs (10) can be transported by the pack path (24) past the drying turret (25), or beneath the same, to the transfer turret (49) such that the packs (10) can be pushed into the drying pockets (63) from the transfer turret (49) counter to the original transporting direction.
